(19) United States
(12) Patent Application Publication
(10) Pub. No.: US 2022/0360666 A1
(43) Pub. Date: Nov. 10, 2022

(54) Mobile Terminal Urgent Call Text Initiating and Receiving Display Method

(71) Applicant: Mohsen Medhat Youssef, Manchester, CT (US)

(72) Inventor: Mohsen Medhat Youssef, Manchester, CT (US)

(73) Assignee: Mohsen Medhat Youssef, Manchester, CT (US)

(21) Appl. No.: 17/307,576

(22) Filed: May 4, 2021

(51) Int. Cl. H04M 3/436; H04M 1/7243

(52) U.S. Cl. CPC H04M 3/4365; H04M 1/7243; H04M 2203/2038

(57) ABSTRACT

The present invention provides an urgent initiation and notification method for calls and text messages to and from a mobile terminal.

### BACKGROUND OF THE INVENTION

The current mode of receiving phone calls and text messages on mobile terminals presents no distinction between an Urgent incoming phone call or text message to the mobile terminal vs. an ordinary incoming version. At upon receiving a phone call, the user may not accept the call or open the text message after seeing it if they are engaged in a task, where they would have interrupted the task on hand if they knew it was urgent; although there is no available way for the phone call and text message to appear as Urgent in current mobile terminals. This ‘Mobile Terminal Urgent Call and Text Initiating and Receiving Display Method’ offers the distinguishing on the display screen of mobile terminals between an Urgent incoming signal (call or text message) vs. an ordinary version. This invention also offers the method on how to initiate the Urgent signal for the phone call and text message, from the initiating terminal. And its receiving form that displays the urgent notification display for these 2 signals at the receiving terminal.

### BRIEF DESCRIPTION OF DRAWINGS

FIG. 1

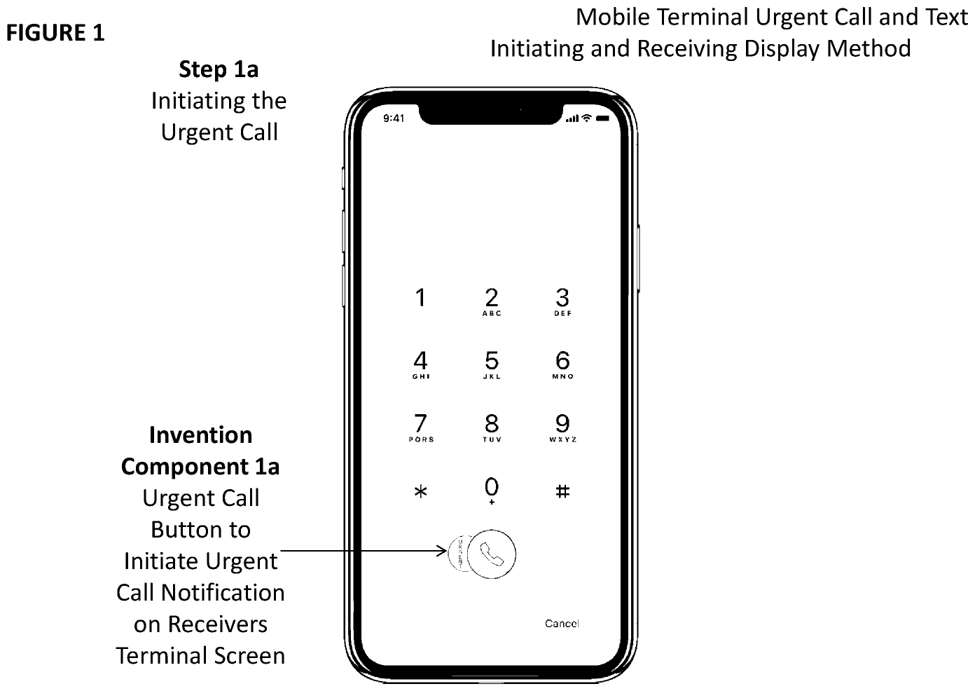

Bottom center of mobile terminal screen—Showing the initiating urgent call button that is a half circle to the left of the main call button. Labeled as ‘URGENT’ in vertical format. Pressing this Urgent Call Button initiates urgent call notification on receivers terminal screen (as shown in FIGS. 3 and 4).

FIG. 2

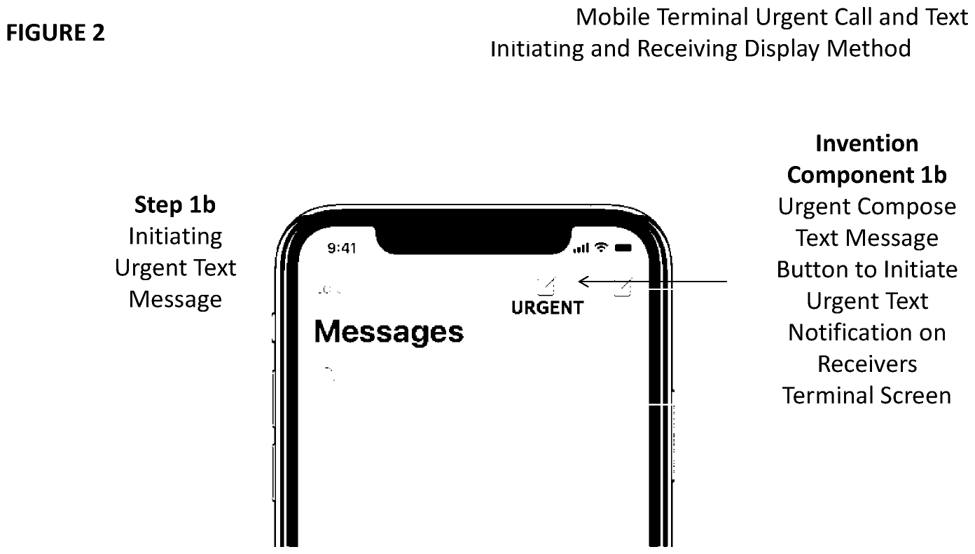

Top right of mobile terminal screen—Showing the urgent text message initiating button. Labeled as ‘URGENT’ in horizontal format. Pressing this Urgent Text Message button initiates urgent text message notification on receivers terminal screen (as show in FIG. 4).

FIG. 3

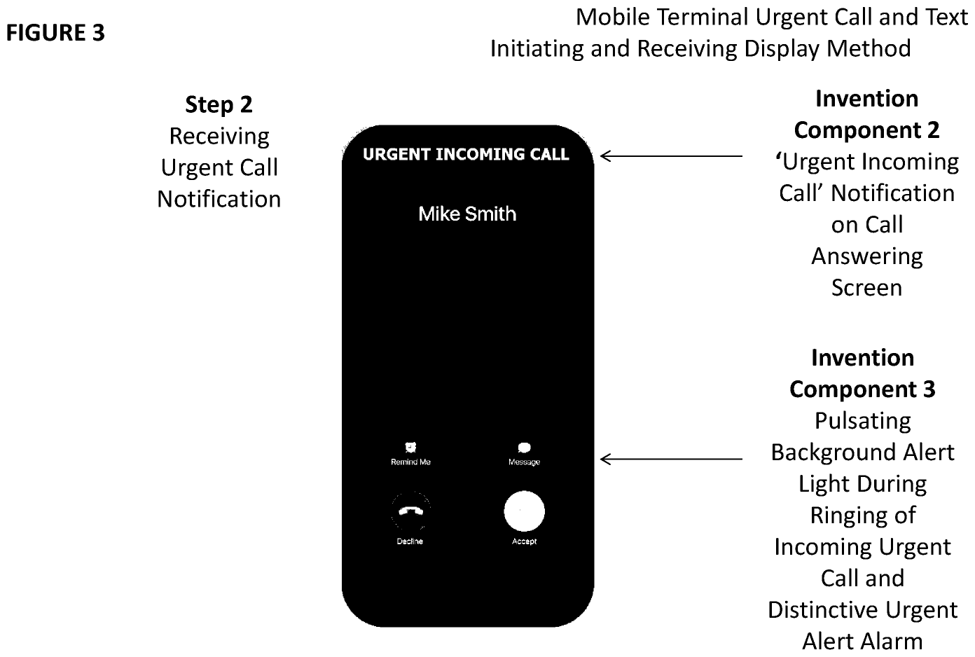

Top of mobile terminal screen—Showing the Receiving Urgent Call Notification which is the result of the initiating user pressing the ‘URGENT’ call button. Allowing for ‘Urgent Incoming Call’ Notification on Call Answering Screen of the receiver. With Pulsating Background Alert Light During Ringing of Incoming Urgent Call and Distinctive Urgent Alert Alarm.

FIG. 4

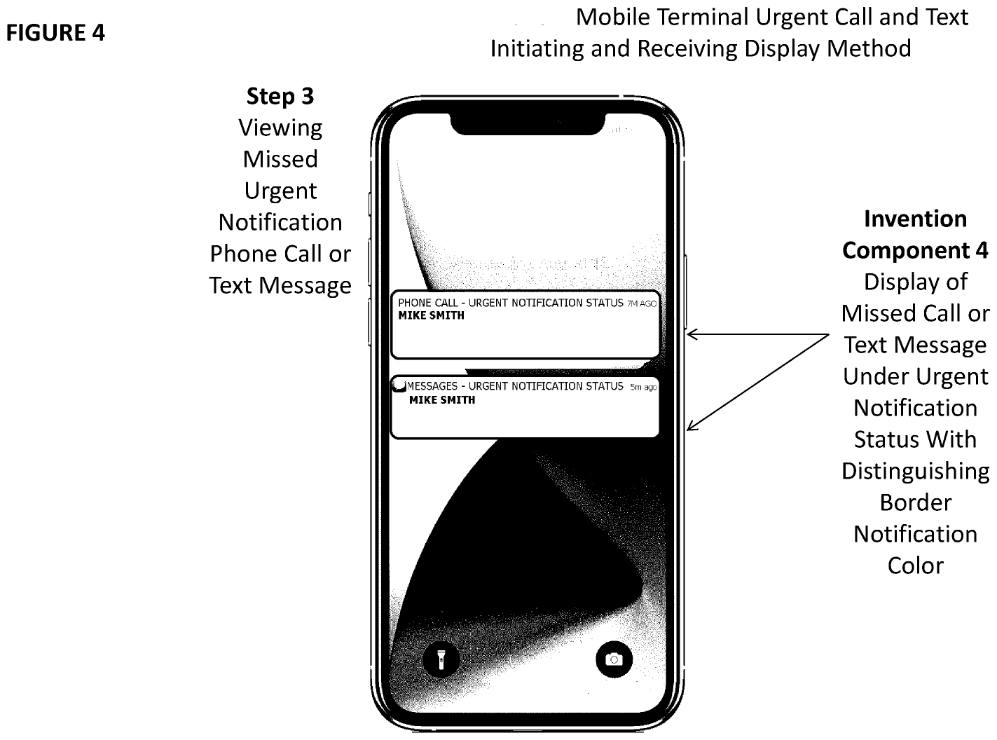

Center of mobile terminal screen—Showing the Missed Urgent Notification Phone Call or Text Message. The Display of Missed Call or Text Message Under Urgent Notification Status With Distinguishing Border Notification Color.

1. This patent is claiming the new feature in mobile terminals of providing a method to initiate an urgent call and text message, and a feature method of how the mobile terminal displays that Urgent call/text message from the sender on the receivers mobile terminal .
